(19) United States
(12) Patent Application Publication
(10) Pub. No.: US 2026/0285765 A1
(43) Pub. Date: Sep. 24, 2026

(54) DIELECTRIC CERAMIC COMPOSITION AND MULTILAYER CERAMIC ELECTRONIC DEVICE

(71) Applicant: TDK Corporation, Tokyo (JP)

(72) Inventors: Ryota NAMIKI, Tokyo (JP); Toshihiro IGUCHI, Tokyo (JP); Taku MURAKAMI, Tokyo (JP)

(73) Assignee: TDK Corporation, Tokyo (JP)

(21) Appl. No.: 19/568,213

(22) Filed: Mar. 16, 2026

(30) Foreign Application Priority Data
Mar. 19, 2025 (JP) 2025-045493

(51) Int. Cl. C04B 35/49; H01G 4/12

(52) U.S. Cl. CPC C04B 35/49; H01G 4/1245; C04B 2235/3217; C04B 2235/3249; C04B 2235/3258; C04B 2235/3262; C04B 2235/3418; C04B 2235/768

(57) ABSTRACT

A dielectric ceramic composition contains a perovskite-type compound represented by the composition formula (Ca₁₋ₓ₋ₚSrₓBaₚ)ₘ(Zr_{1-y-z}Ti_{y}Hf_{z})O₃. The values x, p, m, y, and z are within a predetermined range. The dielectric ceramic composition contains Al, Si, Z, and at least one selected from the group consisting of Mn and Mg. Z includes at least one selected from the group consisting of V, Nb, Ta, and W. A content of Al is 0.01 parts by mole or more and 1.00 part by mole or less in terms of Al₂O₃, a content of Si is 0.08 parts by mole or more and 4.0 parts by mole or less in terms of SiO₂, the total content of Mn and Mg is 0.10 parts by mole or more and 5.0 parts by mole or less, and the total content of Z is 0.005 parts by mole or more and 0.80 parts by mole or less.

### TECHNICAL FIELD

The present disclosure relates to a dielectric ceramic composition and a multilayer ceramic electronic device.

### BACKGROUND

Patent Document 1 discloses a reduction-resistant dielectric ceramic composition and a multilayer ceramic capacitor that is formed by alternately laminating electrodes and ceramic sheets composed of the reduction-resistant dielectric ceramic composition.

### PATENT DOCUMENT

Patent Document 1: JP Patent Application Laid Open No. 2007-091588

### SUMMARY

A dielectric ceramic composition according to the present disclosure contains:
a perovskite-type compound represented by the composition formula (Ca₁₋ₓ₋ₚSrₓBaₚ)ₘ(Zr_{1-y-z}Ti_{y}Hf_{z})O₃ as a main component in terms of number of atoms,
in which the following conditions are satisfied:
0≤x<1.00, 0≤p<1.00, 0.9<m<1.1, 0≤y≤0.10, and 0≤z<1.00,
the dielectric ceramic composition further contains Al, Si, Z, and at least one selected from the group consisting of Mn and Mg,
Z includes at least one selected from the group consisting of V, Nb, Ta, and W,
with respect to 100 parts by mole of the total content of Zr, Ti, and Hf, a content of Al is 0.01 parts by mole or more and 1.00 part by mole or less in terms of Al₂O₃, a content of Si is 0.08 parts by mole or more and 4.0 parts by mole or less in terms of SiO₂, the total content of Mn and Mg is 0.10 parts by mole or more and 5.0 parts by mole or less, and the total content of Z is 0.005 parts by mole or more and 0.80 parts by mole or less.

### BRIEF DESCRIPTION OF THE DRAWINGS

FIG. 1 is a schematic view illustrating a cross-section of a multilayer ceramic capacitor according to an embodiment of the present disclosure.

### DETAILED DESCRIPTION

An object of the present disclosure is to obtain a dielectric ceramic composition capable of providing a multilayer ceramic electronic device having high reliability while maintaining satisfactory temperature characteristics.

In the dielectric ceramic composition according to the present disclosure, the following conditions may be satisfied: 0≤x<0.80, 0≤p<0.40, 0.9<m<1.1, 0≤y≤0.10, and 0≤z<0.20, and the total content of Z may be 0.02 parts by mole or more and 0.75 parts by mole or less.

In the dielectric ceramic composition according to the present disclosure, the following conditions may be satisfied: 0≤x<0.40, p=0, 0.9<m<1.1, 0.01<y≤0.10, and 0≤z<0.20, and the total content of Z may be 0.02 parts by mole or more and 0.75 parts by mole or less.

In the dielectric ceramic composition according to the present disclosure, when a value obtained by dividing the total content of Z by a content of Mn is set as Z/Mn, a value obtained by dividing the total content of Z by the content of Al is set as Z/Al, and a value obtained by dividing the total content of Z by the content of Si is set as Z/Si,
the following conditions may be satisfied: 0.005≤Z/Mn<1.50, 0.05≤Z/Al<1.50, and 0.010≤Z/Si<0.45.

In the dielectric ceramic composition according to the present disclosure, Z may include at least one selected from the group consisting of W and Nb.

In the dielectric ceramic composition according to the present disclosure, Z may include W.

In the dielectric ceramic composition according to the present disclosure, a relationship of 0.01<y≤0.07 may be satisfied.

In the dielectric ceramic composition according to the present disclosure, a relationship of 0≤z≤0.01 is satisfied.

In the dielectric ceramic composition according to the present disclosure, a content of each element other than Ca, Sr, Ba, Zr, Ti, Hf, O, Mn, Mg, Al, Si, and Z is 0 parts by mole or more and 5.0 parts by mole or less, with respect to 100 parts by mole of the total content of Zr, Ti, and Hf.

According to another aspect of the present disclosure, a multilayer ceramic electronic device contains the dielectric ceramic composition.

Hereinafter, the present disclosure will be described based on specific embodiments.

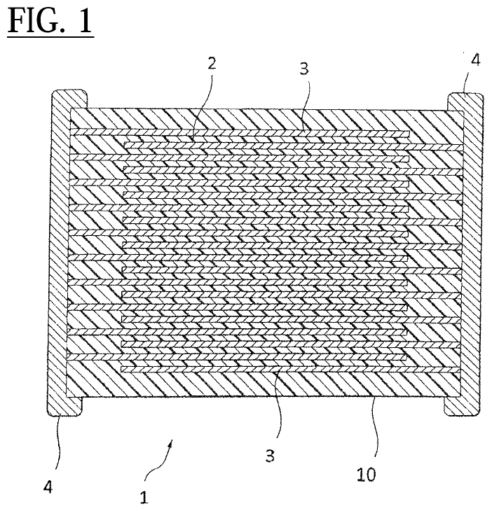

As an example of an electronic component according to the present embodiment, a multilayer ceramic capacitor 1 is illustrated in FIG. 1. The multilayer ceramic capacitor 1 includes an element body 10 having a configuration in which dielectric layers 2 and inner electrode layers 3 are laminated alternately. A pair of outer electrodes 4, which are electrically connected to the inner electrode layers 3 disposed alternately at the inside of the element body 10, are formed at both ends of the element body 10. The shape of the element body 10 is not particularly limited, but the shape is typically set to a rectangular parallelepiped shape. In addition, the dimensions of the element body 10 are also not particularly limited, and may be set to appropriate dimensions depending on the intended application.

The dielectric layers 2 contain a dielectric ceramic composition according to the present embodiment to be described later. The thickness (interlayer thickness) of each of the dielectric layers 2 is not particularly limited, and can be arbitrarily set depending on desired characteristics, applications, and the like. Typically, the interlayer thickness may be 100 μm or less, or may be 30 μm or less. In addition, the number of the laminated dielectric layers 2 is not particularly limited, but in the present embodiment, the laminating number may be, for example, 20 or more.

The inner electrode layers 3 are laminated such that respective cross-sections are alternately exposed to surfaces of the two facing ends of the element body 10.

The main component of a conductive material contained in each of the inner electrode layers 3 is a metal. The metal is not particularly limited, and for example, a conductive material known as a metal such as Pd, a Pd-based alloy, Pt, a Pt-based alloy, Ni, a Ni-based alloy, Cu, or a Cu-based alloy may be used. The metal may contain various minor components such as P, S, and Cl, each in an amount of approximately 0.1 mass % or less. The inner electrode layer 3 may be formed using a commercially available electrode paste. The thickness of the inner electrode layer 3 may be appropriately determined depending on the intended application.

A conductive material contained in the outer electrodes 4 is not particularly limited. For example, a known conductive material such as Ni, Cu, Sn, Ag, Pd, Pt, Au, alloys thereof, or a conductive resin may be used. The thickness of each of the outer electrodes 4 may be appropriately determined depending on the intended application.

The dielectric ceramic composition according to the present embodiment contains a perovskite-type compound represented by the composition formula (Ca₁₋ₓ₋ₚSrₓBaₚ)ₘ(Zr_{1-y-z}Ti_{y}Hf_{z}) O₃ as a main component in terms of number of atoms. Then, the following conditions are satisfied: 0≤x<1.00, 0≤p<1.00, 0.9<m<1.1, 0≤y≤0.10, and 0≤z<1.00.

The perovskite-type compound is a compound having a perovskite-type crystal structure represented by the general formula ABO₃ (A is an A-site element, and B is a B-site element).

As described above, the perovskite-type compound according to the present embodiment contains at least Ca and/or Sr as the A-site element. At least Zr and/or Ti are contained as the B-site element.

The dielectric ceramic composition according to the present embodiment further contains an oxide of an additive element other than the perovskite-type compound.

As the additive element, at least one selected from the group consisting of Mn and Mg, Al, Si, and Z are essentially contained. Z includes at least one selected from the group consisting of V, Nb, Ta, and W. Z may be at least one selected from the group consisting of W and Nb, and Z may be W.

With respect to 100 parts by mole of the total content of Zr, Ti, and Hf (B-site elements of the perovskite-type compound), a content of Al is 0.01 parts by mole or more and 1.00 part by mole or less in terms of Al₂O₃, a content of Si is 0.08 parts by mole or more and 4.0 parts by mole or less in terms of SiO₂, the total content of Mn and Mg is 0.10 parts by mole or more and 5.0 parts by mole or less, and the total content of Z is 0.005 parts by mole or more and 0.80 parts by mole or less.

When at least one selected from the group consisting of Mn and Mg, Al, and Si are contained, sintering is promoted. Furthermore, when Z is contained, reliability is improved while satisfactorily maintaining temperature characteristics. That is, high-temperature load life is lengthened while maintaining the temperature characteristics in a satisfactory manner.

The total content of Mn and Mg is calculated by adding the content of Mn calculated in terms of MnO and the content of Mg calculated in terms of MgO.

The following conditions may be satisfied: 0≤x<0.80, 0≤p<0.40, 0.9<m<1.1, 0≤y≤0.10, and 0≤z<0.20. Furthermore, the total content of Z may be 0.02 parts by mole or more and 0.75 parts by mole or less.

The following conditions may be satisfied: 0≤x<0.40, p=0, 0.9<m<1.1, 0.01<y≤0.10, and 0≤z<0.20. Furthermore, the total content of Z may be 0.02 parts by mole or more and 0.75 parts by mole or less.

Furthermore, the following conditions may be satisfied: 0.01<y≤0.07 may be satisfied. In addition, a relationship of 0≤z≤0.01.

When in terms of number of atoms, a value obtained by dividing the total content of Z by a content of Mn is set as Z/Mn, a value obtained by dividing the total content of Z by the content of Al is set as Z/Al, and a value obtained by dividing the total content of Z by the content of Si is set as Z/Si, the following conditions may be satisfied: 0.005≤Z/Mn<1.50, 0.05≤Z/Al<1.50, and 0.010≤Z/Si<0.45.

When the respective parameters are within the above-described ranges, the reliability is more likely to be further improved.

On the other hand, in a case where the content of Al is excessively small, the reliability deteriorates. When y is excessively large, that is, the content of Ti in the B-site elements is excessively large, the temperature characteristics deteriorate. When the perovskite-type compound is BaTiO₃, the temperature characteristics deteriorate and the reliability also deteriorates.

When Z is not contained, the reliability deteriorates. Also, when the entire amount of Z is replaced with an element other than Z, the reliability deteriorates. However, after setting the contents of the A-site element, the B-site element, O, Mn, Mg, Al, Si, and Z in the dielectric ceramic composition within predetermined ranges, the dielectric ceramic composition may further contain other elements within a range not deteriorating the temperature characteristics and the reliability. For example, the other elements may be contained each in an amount of 5.0 parts by mole or less per 100 parts by mole of the total content of the B-site elements.

When the total content of Z is excessively small or large, the reliability deteriorates.

In the dielectric ceramic composition, 99% by weight or more of the A-site element, the B-site element, and the additive element is contained as a simple oxide or a composite oxide.

Hereinafter, an example of a method for manufacturing the multilayer ceramic capacitor 1 illustrated in FIG. 1 will be described.

First, a process of manufacturing the element body 10 will be described. In the process of manufacturing the element body 10, a dielectric paste that becomes the dielectric layer 2 after firing, and an inner electrode paste that becomes the inner electrode layer 3 after firing are prepared.

The method for producing the dielectric paste is not particularly limited. For example, the dielectric paste is produced by the following method. First, a raw material powder (hereinafter, may be described as “main component raw material powder) of a main component of mainly the dielectric ceramic composition is prepared. A commercially available perovskite-type compound powder may be prepared as the raw material powder. In addition, the raw material powder may be prepared by preparing an oxide powder of the A-site element and an oxide powder of the B-site element of the perovskite-type compound, dispersing the powders in a solvent (for example, purified water), drying the resultant solution, and performing a heat treatment. The holding temperature in the heat treatment for preparing the raw material powder is not particularly limited. For example, the holding temperature may be 900° C. or higher and 1300° C. or lower. The holding time is not particularly limited. For example, the holding time may be 0.5 hours or longer and 5 hours or shorter.

In addition, oxide powders of additive elements may be simultaneously dispersed in the solvent in combination with the oxide powder of the A-site element and the oxide powder of the B-site element of the perovskite-type compound.

A powder of a compound that becomes an oxide of each element by sintering, for example, a powder of a carbonate of each element, a powder of a chloride of each element, or a powder of a hydroxide of each element may be used instead of the oxide powder of each element. In addition, a powder of a composite compound of each element may be used.

A part of the oxide powders of the additive elements is added as sintering aids obtained from Al₂O₃, MnCO₃, and SiO₂. The sintering aids are prepared by mixing powders consisting of the three kinds of compounds and calcining the resultant mixture. The amount of the sintering aids added is not particularly limited, but 1 part by weight or more and 5 parts by weight or less of sintering aids may be added with respect to 100 parts by weight of perovskite-type compound powder.

The content of MnCO₃ in a mixed powder before the calcination may be 55% by weight or more and 75% by weight or less, the content of Al₂O₃ may be 2% by weight or more and 15% by weight or less, and the content of SiO₂ may be 15% by weight or more and 40% by weight or less. With regard to calcination conditions, for example, a firing temperature may be 800° C. or higher and 1200° C. or lower, and the holding time may be 1 hour or longer and 5 hours or shorter.

Next, after obtaining a mixture by mixing the main component raw material powder and the sintering aids, a dielectric powder is prepared by dispersing the resultant mixture and an oxide powder of an additive element (a powder of a compound that becomes an oxide of each element by sintering may be used) in a solvent (for example, purified water), by drying the resultant solution, and by performing a heat treatment. The holding temperature during the heat treatment is not particularly limited. For example, the holding temperature may be 100° C. or higher and 300° C. or lower. The holding time is not particularly limited. For example, the holding time may be 0.5 hours or longer and 5 hours or shorter.

After at least a part of the oxide powder of the additive element is calcined in advance to obtain a calcined product, the above-described mixture, the calcined product, and the oxide powder of the additive element that is not calcined may be dispersed together in a solvent. As calcination conditions in this case, for example, a firing temperature may be 700° C. or higher and 1300° C. or lower, and the holding time may be 1 hour or longer and 5 hours or shorter.

After mixing the main component raw material powder and the oxide powders of the additive elements other than the sintering aids and calcining the resultant mixture to obtain a calcined product, the calcined product and the sintering aids may be dispersed together in a solvent. With regard to calcination conditions in this case, for example, a temperature may be 700° C. or higher and 1300° C. or lower, and the holding time may be 1 hour or longer and 5 hours or shorter.

Then, the obtained dielectric powder, a binder, and a solvent (an organic solvent or water) are kneaded to produce a dielectric paste. The kinds of the binder and the solvent are not particularly limited. An organic vehicle that is obtained by mixing the binder and the organic solvent may be used instead of the binder and the solvent. The dielectric paste may contain additives such as plasticizers and dispersants as necessary.

The inner electrode paste is obtained by kneading a raw material of the conductive material, a binder, and a solvent (an organic solvent or water). The kinds of the binder and the solvent are not particularly limited. The inner electrode paste may contain additives such as sintering inhibitors and plasticizers as necessary.

A green sheet and an inner electrode pattern are formed using the respective obtained pastes, and are laminated to obtain a green chip.

A binder removal treatment may be performed on the obtained green chip as necessary. Binder removal treatment conditions may be known condition. For example, the holding temperature may be set to 180° C. or higher and 400° C. or lower, and the holding time may be set to 0.5 hours or longer and 24 hours or shorter. In addition, an atmosphere during the binder removal treatment is also not particularly limited. In addition, the holding temperature under a reducing atmosphere may be set to 1100° C. or lower.

After the binder removal treatment, the green chip is fired to obtain the element body 10. In the present embodiment, an atmosphere during firing may be set to a reducing atmosphere with an oxygen partial pressure of 2.0×10⁻¹³ atm or more and 1.0×10⁻⁷ atm or less. The other firing conditions may be set to known conditions. For example, the holding temperature may be set to 1200° C. or higher and 1400° C. or lower, and the holding time may be set to 0.5 hours or longer and 8 hours or shorter.

After the firing, an annealing treatment may be performed as necessary. Annealing treatment conditions are not particularly limited. For example, the holding temperature may be set to 500° C. or higher and 1150° C. or lower, and the holding time may be set to 0.5 hours or longer and 20 hours or shorter. An oxygen partial pressure in an annealing atmosphere may be set to, for example, 1.0×10⁻⁹ atm or more and 3.0×10⁻⁵ atm or less.

The dielectric ceramic composition constituting the dielectric layer 2 of the element body 10, which is obtained as described above, is the above-described dielectric ceramic composition. An end surface of the element body 10 is polished as necessary, and an outer electrode paste is applied and baked to form the outer electrodes 4. Then, a coating layer is formed on a surface of the outer electrodes 4 by plating or the like as necessary. The method for preparing the outer electrode paste is not particularly limited, and the outer electrode paste may be prepared by a similar method as in the inner electrode paste.

As described above, the multilayer ceramic capacitor 1 according to the present embodiment is manufactured.

Hereinbefore, the embodiment of the present disclosure has been described, but the present disclosure is not limited to the above-described embodiment, and various modifications can be made within a range not departing from the gist of the present disclosure.

### EXAMPLES

Hereinafter, the present disclosure will be described with reference to more detailed examples, but the present disclosure is not limited to the examples.

### Experimental Example 1

In Experimental Example 1, the multilayer ceramic capacitor 1 illustrated in FIG. 1 was manufactured in the following procedure.

First, the dielectric paste was prepared.

A raw material powder (hereinafter, may be described as a main component raw material powder) of the perovskite-type compound contained as a main component of the main phase grains was prepared. Specifically, a raw material powder of a Ca oxide, a raw material powder of a Sr oxide, a raw material powder of a Ba oxide, a raw material powder of a Zr oxide, and a raw material powder of a Ti oxide, and a raw material powder of a Hf oxide were prepared and weighed to obtain perovskite-type compounds having dielectric compositions shown in Table 1. The term “a raw material powder of a y oxide” represents a powder of the y oxide and/or a powder of a compound that becomes the y oxide by heat treatment. Then, respective powders were dispersed in purified water, and the resultant dispersed solution was dried and subjected to a heat treatment (the holding temperature was 1150° C. to 1250° C., and the holding time was 0.5 to 5 hours) to prepare a main component raw material powder.

Additionally, sintering aids were prepared. 64.8% by weight of MnCO₃ powder, 7.5% by weight of Al₂O₃ powder, and 27.7% by weight of SiO₂ powder were mixed and calcined. With regard to calcination conditions, a firing temperature was set o 1000° C. and the holding time was set to 2 hours. In Sample Nos. 6 and 7, 65.5% by weight of MnCO₃ powder and 34.5% by weight of SiO₂ powder were mixed and calcined.

Additionally, the sintering aids and powders of oxides of additive elements (a raw material powder of a Mn oxide, a raw material powder of a Mg oxide, a SiO₂ powder, an Al₂O₃ powder, and/or a raw material powder of an oxide of Z) were prepared and weighed such that oxides of respective elements were contained in the dielectric ceramic composition in contents shown in Table 1. In all examples, with respect to 100 parts by weight of the content of the main component raw material powder, 1 to 5 parts by weight of the sintering aids was contained. However, in a case where the content of any element of Mn, Si, and Al was excessively large when using 1 part by weight of sintering aids in samples other than Sample Nos 6 and 7, the amount of the sintering aids used was increased as much as possible within a range of less than 1 part by weight. Content ratios of Mn, Al, and Si in the finally obtained dielectric ceramic composition, the contents of Z, Z/Mn, Z/Al, and Z/Si are shown in Table 1. In experimental examples other than Experimental Example 3 to be described later, the content of Z is the same as the content of W.

The content of Al is expressed in terms of Al₂O₃, the content of Si shown in terms of SiO₂, and the content of Z is expressed in terms of ZO_{q}. When the number of atoms of Z is set to 1, the number of atoms of O is set to q. For example, when Z is W, the content of W is expressed in terms of WO₃. The content of Mg is 0 other than Sample No. 5. In Sample No. 5, the content of Mg is 0.50 parts by mole. The contents in respective experimental examples are values based on 100 parts by mole of the total content of the B-site elements, that is, the total content of Zr, Hf, and Ti.

After obtaining a mixture by mixing the main component raw material powder and the sintering aids, a dielectric powder was obtained by dispersing the mixture and the powder of the oxide of the additive element in purified water, drying the resultant solution, and by performing a heat treatment. The holding temperature was set to 150° C., and the holding time was set to 2.0 hours.

The dielectric powder and an organic vehicle were kneaded to prepare a dielectric paste. 100 parts by mass of the dielectric powder, 10 parts by mass of polyvinyl butyral resin, 5 parts by mass of dioctyl phthalate (DOP) as a plasticizer, and 100 parts by mass of alcohol as a solvent were mixed with a ball mill to be a paste, thereby obtaining the dielectric paste.

A method for preparing the inner electrode paste is as follows. First, a Ni powder, terpineol, ethyl cellulose, and benzotriazole were prepared in a mass ratio of 44.6:52.0:3.0:0.4. Then, these were kneaded by three rolls to be paste, thereby preparing the inner electrode paste.

Next, a green chip was manufactured by a sheet forming method using the above-described dielectric paste and the inner electrode paste. Then, the green chip was subjected to a binder removal treatment, a firing treatment, and an annealing treatment to obtain a rectangular parallelepiped element body 10 having dimensions of 3.2 mm×1.6 mm×0.7 mm. With regard to the dimensions, a dimension in a horizontal direction in FIG. 1 is 3.2 mm, and a dimension in a vertical direction (laminating direction) in FIG. 1 is 0.7 mm. In the firing treatment, the holding temperature during the firing treatment was set to 1200° C. to 1300° C., the holding time was set to 2.0 hours, an atmosphere during the firing was set to a reducing atmosphere with an oxygen partial pressure of 2.0×10⁻¹³ atm or more and 1.0×10⁻⁷ atm or less. In addition, in the obtained element body 10, the number of the laminated dielectric layers 2 each being sandwiched between the inner electrode layers 3 was set to 10, an average thickness of the dielectric layers 2 each being sandwiched between the inner electrode layer 3 was set to 5.0 μm, and an average thickness of the inner electrode layers 3 was set to 1.2 μm.

With regard to the holding temperature during the firing, a preliminary test was performed on respective samples at six holding temperatures: 1200° C., 1220° C., 1240° C., 1260° C., 1280° C., and 1300° C. Then, the lowest holding temperature among holding temperatures at which the element body 10 was densified was adopted. Whether the element body 10 was densified was determined by observing a cross-section of the element body 10 using SEM. Specifically, it was determined whether an area of voids in a field of view of 450 μm² or more in a cross-section of the element body 10 was 2% or less of an area of the dielectric layers 2 in the field of view.

Next, a baked electrode layer containing Cu, a Ni plated layer, and a Sn plated layer are sequentially formed in this order on an outer surface of the above-described element body 10 to form the outer electrode 4, thereby obtaining the multilayer ceramic capacitor 1.

### (Composition of Dielectric Ceramic Composition)

With regard to the composition of the dielectric ceramic composition, composition analysis was performed on the dielectric layers 2 using ICP emission spectroscopy. The dielectric composition and the contents of the additive elements were substantially the same between the batch composition and the composition of the dielectric ceramic composition.

### (Temperature Characteristics)

Temperature characteristics of the multilayer ceramic capacitor 1 was evaluated by measuring a temperature coefficient of capacitance τC (unit: ppm/° C.). Specifically, a signal with a frequency of 1 kHz and an input signal level (measurement voltage) of 1 Vrms was applied to the multilayer ceramic capacitor at 25° C. and 125° C., and the capacitance at each temperature was measured. Then, τC was calculated from the capacitance C25 at 25° C. and the capacitance C125 at 125° C. using the following equation:

$$τ C = \{ ( C 125 - C 25 ) / C 25 \} \times \{ 1 / ( 125 - 25 ) \}$$

τC was measured for ten multilayer ceramic capacitors 1, and an average value of τC was calculated. When the average value of τC was −30 ppm/° C. or more and +30 ppm/° C. or less, possible was described in a temperature characteristic column in Table 2. When the average value of τC was less than −30 ppm/° C. or more than +30 ppm/° C., impossible was described in the temperature characteristic column in Table 2.

### (Reliability Test)

High-temperature load life of the multilayer ceramic capacitor 1 was evaluated. Specifically, the multilayer ceramic capacitor 1 was held at 200° C. in a state of being applied with a DC voltage of 800 V (160 V/μm) to measure the service life. In the present examples, the service life was defined as the shortest time between time from the start of application until insulation resistance dropped by one digit and time from the start of application until a sample failed. In the present examples, the above-described evaluation was performed on twenty multilayer ceramic capacitors 1, and a mean time to failure (MTTF) was calculated of the service life of each of the multilayer ceramic capacitor 1. When MTTF was 2.00×10² hours or longer and shorter than 1.00×10³ hours, reliability was evaluated as satisfactory, and in a case where MTTF was 1.00×10³ hours or longer, the reliability was evaluated as particularly satisfactory. The results are shown in Table 1. In Table 1, the notation “rE+s” denotes r×10^{s}.

TABLE 1

| Example/ | | | Additive | MnO | Al₂O₃ | SiO₂ |
|---|---|---|---|---|---|---|
| Comparative | Sample | Perovskite-Type Compound | Elements Other | (parts by | (parts by | (parts by |
| Examaple | No. | (Based on Number of Atoms) | Than Z | mole) | mole) | mole) |
| Example | 1 | (Ca_{0.70}Sr_{0.30})(Zr_{0.90}Ti_{0.09}Hf_{0.01})O₃ | Mn, Al, Si | 1.89 | 0.25 | 1.48 |
| Example | 2 | (Ca_{0.70}Sr_{0.30})(Zr_{0.96}Ti_{0.03}Hf_{0.01})O₃ | Mn, Al, Si | 2.06 | 0.24 | 1.50 |
| Example | 3 | (Ca_{0.70}Sr_{0.30})(Zr_{0.93}Ti_{0.06}Hf_{0.01})O₃ | Mn, Al, Si | 2.29 | 0.24 | 1.45 |
| Example | 4 | CaZrO₃ | Mn, Al, Si | 2.57 | 0.25 | 1.57 |
| Example | 5 | (Ca_{0.70}Sr_{0.30})(Zr_{0.96}Ti_{0.03}Hf_{0.01})O₃ | Mn, Mg, Al, Si | 1.94 | 0.25 | 1.67 |
| Comparative | 6 | (Ca_{0.70}Sr_{0.30})(Zr_{0.96}Ti_{0.03}Hf_{0.01})O₃ | Mn, Si | 2.14 | 0.00 | 1.30 |
| Example | | | | | | |
| Comparative | 7 | (Ca_{0.70}Sr_{0.30})(Zr_{0.60}Ti_{0.40})O₃ | Mn, Si | 2.12 | 0.00 | 1.64 |
| Example | | | | | | |
| Comparative | 8 | BaTiO₃ | Mn, Al, Si | 2.29 | 0.24 | 1.60 |
| Example | | | | | | |

| Example/ | | | Z | | | | | |
|---|---|---|---|---|---|---|---|---|
| Comparative | Sample | Type | (parts by | | | | Temperature | MTTF |
| Examaple | No. | of Z | mole) | Z/Mn | Z/Al | Z/Si | Characteristics | (h) |
| Example | 1 | W | 0.34 | 0.18 | 0.68 | 0.23 | Satisfactory | 1.07.E+03 |
| Example | 2 | W | 0.33 | 0.16 | 0.69 | 0.22 | Satisfactory | 1.36.E+03 |
| Example | 3 | W | 0.32 | 0.14 | 0.66 | 0.22 | Satisfactory | 1.19.E+03 |
| Example | 4 | W | 0.36 | 0.14 | 0.71 | 0.23 | Satisfactory | 1.07.E+03 |
| Example | 5 | W | 0.35 | 0.18 | 0.70 | 0.21 | Satisfactory | 1.22.E+03 |
| Comparative | 6 | W | 0.30 | 0.14 | — | 0.23 | Satisfactory | 6.70.E+01 |
| Example | | | | | | | | |
| Comparative | 7 | W | 0.36 | 0.17 | — | 0.22 | Unsatisfactory | 1.74.E+02 |
| Example | | | | | | | | |
| Comparative | 8 | W | 0.32 | 0.14 | 0.68 | 0.20 | Unsatisfactory | 2.50.E+01 |
| Example | | | | | | | | |

As can be seen from Table 1, in a case where the perovskite-type compound having a predetermined composition is contained as a main component, and the content of each component was within a predetermined range, the temperature characteristics and the reliability were satisfactory.

In contrast, in Sample No. 6 in which Al is not contained, the reliability deteriorated. In Sample No. 7 in which Al is not contained and the content of Ti is excessively large, the temperature characteristics were insufficient, and the reliability deteriorated. In Sample No. 8 in which the main component is barium titanate, the temperature characteristics were insufficient, and the reliability deteriorated.

### Experimental Example 2

Sample Nos. 11 to 14 were obtained by changing mainly the ratio of Ti in the B-site elements with respect to Samples Nos. 1 and 2, and the same experiment as in Experimental Example 1 was performed. The results are shown in Table 2.

TABLE 2

| Example/ | | | Additive | MnO | Al₂O₃ | SiO₂ |
|---|---|---|---|---|---|---|
| Comparative | Sample | Perovskite-Type Compound | Elements Other | (parts by | (parts by | (parts by |
| Example | No. | (Based on Number of Atoms) | Than Z | mole) | mole) | mole) |
| Example | 11 | (Ca_{0.70}Sr_{0.30})(Zr_{0.98}Hf_{0.02})O₃ | Mn, Al, Si | 2.50 | 0.25 | 1.52 |
| Example | 2 | (Ca_{0.70}Sr_{0.30})(Zr_{0.96}Ti_{0.03}Hf_{0.01})O₃ | Mn, Al, Si | 2.06 | 0.24 | 1.50 |
| Example | 12 | (Ca_{0.70}Sr_{0.30})(Zr_{0.92}Ti_{0.07}Hf_{0.01})O₃ | Mn, Al, Si | 2.07 | 0.23 | 1.29 |
| Example | 1 | (Ca_{0.70}Sr_{0.30})(Zr_{0.90}Ti_{0.09}Hf_{0.01})O₃ | Mn, Al, Si | 1.89 | 0.25 | 1.48 |
| Example | 13 | (Ca_{0.70}Sr_{0.30})(Zr_{0.89}Ti_{0.10}Hf_{0.01})O₃ | Mn, Al, Si | 2.14 | 0.23 | 1.50 |
| Comparative | 14 | (Ca_{0.70}Sr_{0.30})(Zr_{0.88}Ti_{0.12})O₃ | Mn, Al, Si | 2.36 | 0.24 | 1.38 |
| Example | | | | | | |

| Example/ | | | Z | | | | | |
|---|---|---|---|---|---|---|---|---|
| Comparative | Sample | Type | (parts by | | | | Temperature | MTTF |
| Example | No. | of Z | mole) | Z/Mn | Z/Al | Z/Si | Characteristics | (h) |
| Example | 11 | W | 0.35 | 0.14 | 0.70 | 0.23 | Satisfactory | 1.26.E+03 |
| Example | 2 | W | 0.33 | 0.16 | 0.69 | 0.22 | Satisfactory | 1.36.E+03 |
| Example | 12 | W | 0.31 | 0.15 | 0.67 | 0.24 | Satisfactory | 1.27.E+03 |
| Example | 1 | W | 0.34 | 0.18 | 0.68 | 0.23 | Satisfactory | 1.07.E+03 |
| Example | 13 | W | 0.30 | 0.14 | 0.66 | 0.20 | Satisfactory | 1.35.E+03 |
| Comparative | 14 | W | 0.33 | 0.14 | 0.70 | 0.24 | Unsatisfactory | 1.84.E+02 |
| Example | | | | | | | | |

As can be seen from Table 2, in Sample Nos. 11 to 13 in which the ratio (y) of Ti in the B-site element is 0 or more and 0.10 or less, the temperature characteristics and the reliability were satisfactory.

In contrast, in Sample No. 14 in which the ratio (y) of Ti in the B-site elements is excessively large, the temperature characteristics were insufficient.

### Experimental Example 3

Sample Nos. 21 to 29 were obtained by changing mainly the type of Z from Sample No. 2, and the same experiment as in Experimental Example 1 was performed. In Sample No. 21, the ratio of W and Nb was 1:1 in terms of number of atoms, and in Sample No. 22, the ratio of W and Ta was 1:1 in terms of number of atoms. In Sample No. 26, Mo was contained instead of Z. In Sample No. 27, Y was contained instead of Z. In Sample No. 28, Dy was contained instead of Z. In Sample No. 29, substantially only the oxide of Mn, the oxide of Al, and the oxide of Si were contained in addition to the main component.

TABLE 3

| Example/ | | | Additive | MnO | Al₂O₃ | SiO₂ |
|---|---|---|---|---|---|---|
| Comparative | Sample | Perovskite-Type Compound | Elements Other | (parts by | (parts by | (parts by |
| Example | No. | (Based on Number of Atoms) | Than Z | mole) | mole) | mole) |
| Example | 2 | (Ca_{0.70}Sr_{0.30})(Zr_{0.96}Ti_{0.03}Hf_{0.01})O₃ | Mn, Al, Si | 2.06 | 0.24 | 1.50 |
| Example | 21 | (Ca_{0.70}Sr_{0.30})(Zr_{0.96}Ti_{0.03}Hf_{0.01})O₃ | Mn, Al, Si | 1.94 | 0.24 | 1.43 |
| Example | 22 | (Ca_{0.70}Sr_{0.30})(Zr_{0.96}Ti_{0.03}Hf_{0.01})O₃ | Mn, Al, Si | 2.29 | 0.24 | 1.45 |
| Example | 23 | (Ca_{0.70}Sr_{0.30})(Zr_{0.96}Ti_{0.03}Hf_{0.01})O₃ | Mn, Al, Si | 2.13 | 0.24 | 1.42 |
| Example | 24 | (Ca_{0.70}Sr_{0.30})(Zr_{0.96}Ti_{0.03}Hf_{0.01})O₃ | Mn, Al, Si | 2.06 | 0.26 | 1.75 |
| Example | 25 | (Ca_{0.70}Sr_{0.30})(Zr_{0.96}Ti_{0.03}Hf_{0.01})O₃ | Mn, Al, Si | 1.72 | 0.23 | 1.29 |
| Comparative | 26 | (Ca_{0.70}Sr_{0.30})(Zr_{0.96}Ti_{0.03}Hf_{0.01})O₃ | Mn, Al, Si | 1.80 | 0.23 | 1.52 |
| Example | | | | | | |
| Comparative | 27 | (Ca_{0.70}Sr_{0.30})(Zr_{0.96}Ti_{0.03}Hf_{0.01})O₃ | Mn, Al, Si | 1.82 | 0.23 | 1.46 |
| Example | | | | | | |
| Comparative | 28 | (Ca_{0.70}Sr_{0.30})(Zr_{0.96}Ti_{0.03}Hf_{0.01})O₃ | Mn, Al, Si | 1.90 | 0.25 | 1.59 |
| Example | | | | | | |
| Comparative | 29 | (Ca_{0.70}Sr_{0.30})(Zr_{0.96}Ti_{0.03}Hf_{0.01})O₃ | Mn, Al, Si | 2.10 | 0.24 | 1.39 |
| Example | | | | | | |

| Example/ | | | Z | | | | | |
|---|---|---|---|---|---|---|---|---|
| Comparative | Sample | Type | (parts by | | | | Temperature | MTTF |
| Example | No. | of Z | mole) | Z/Mn | Z/Al | Z/Si | Characteristics | (h) |
| Example | 2 | W | 0.33 | 0.16 | 0.69 | 0.22 | Satisfactory | 1.36.E+03 |
| Example | 21 | W, Nb | 0.33 | 0.17 | 0.68 | 0.23 | Satisfactory | 1.26.E+03 |
| Example | 22 | W, Ta | 0.32 | 0.14 | 0.66 | 0.22 | Satisfactory | 1.23.E+03 |
| Example | 23 | Nb | 0.34 | 0.16 | 0.71 | 0.24 | Satisfactory | 1.16.E+03 |
| Example | 24 | Ta | 0.35 | 0.17 | 0.67 | 0.20 | Satisfactory | 1.11.E+03 |
| Example | 25 | V | 0.31 | 0.18 | 0.67 | 0.24 | Satisfactory | 1.02.E+03 |
| Comparative | 26 | Without Z (Mo0.32 parts by mole) | | | | | Satisfactory | 7.90.E+01 |
| Example | | | | | | | | |
| Comparative | 27 | Without Z (Y0.32 parts by mole) | | | | | Satisfactory | 1.12.E+02 |
| Example | | | | | | | | |
| Comparative | 28 | Without Z (Dy0.35 parts by mole) | | | | | Satisfactory | 1.22.E+02 |
| Example | | | | | | | | |
| Comparative | 29 | Without Z | | | | | Satisfactory | 1.26.E+02 |
| Example | | | | | | | | |

As can be seen from Table 3, in Sample Nos. 21 to 25 in which the type of Z was changed from Sample No. 2, the temperature characteristics and the reliability were satisfactory. In contrast, in Sample Nos. 26 to 28 in which an element other than Z was used instead of W, and in Sample No. 29 in which W was excluded from Sample No. 2, the reliability deteriorated.

### Experimental Example 4

The same experiment was performed in a similar manner as in Sample No. 2, except that the content of W was mainly changed, and the contents of other elements were also changed accordingly. The results are shown in Table 4.

TABLE 4

| Example/ | | | Additive | MnO | Al₂O₃ | SiO₂ |
|---|---|---|---|---|---|---|
| Comparative | Sample | Perovskite-Type Compound | Elements Other | (parts by | (parts by | (parts by |
| Example | No. | (Based on Number of Atoms) | Than Z | mole) | mole) | mole) |
| Comparative | 29 | (Ca_{0.70}Sr_{0.30})(Zr_{0.96}Ti_{0.03}Hf_{0.01})O₃ | Mn, Al, Si | 2.10 | 0.24 | 1.39 |
| Example | | | | | | |
| Comparative | 30 | (Ca_{0.70}Sr_{0.30})(Zr_{0.96}Ti_{0.03}Hf_{0.01})O₃ | Mn, Al, Si | 0.13 | 0.01 | 0.08 |
| Example | | | | | | |
| Example | 31 | (Ca_{0.70}Sr_{0.30})(Zr_{0.96}Ti_{0.03}Hf_{0.01})O₃ | Mn, Al, Si | 0.30 | 0.01 | 0.12 |
| Example | 32 | (Ca_{0.70}Sr_{0.30})(Zr_{0.96}Ti_{0.03}Hf_{0.01})O₃ | Mn, Al, Si | 1.00 | 0.02 | 0.30 |
| Example | 2 | (Ca_{0.70}Sr_{0.30})(Zr_{0.96}Ti_{0.03}Hf_{0.01})O₃ | Mn, Al, Si | 2.06 | 0.24 | 1.50 |
| Example | 33 | (Ca_{0.70}Sr_{0.30})(Zr_{0.96}Ti_{0.03}Hf_{0.01})O₃ | Mn, Al, Si | 2.20 | 0.50 | 2.00 |
| Example | 34 | (Ca_{0.70}Sr_{0.30})(Zr_{0.96}Ti_{0.03}Hf_{0.01})O₃ | Mn, Al, Si | 2.20 | 0.50 | 2.00 |
| Comparative | 35 | (Ca_{0.70}Sr_{0.30})(Zr_{0.96}Ti_{0.03}Hf_{0.01})O₃ | Mn, Al, Si | 2.20 | 0.50 | 2.10 |
| Example | | | | | | |

| Example/ | | | Z | | | | | |
|---|---|---|---|---|---|---|---|---|
| Comparative | Sample | Type | (parts by | | | | Temperature | MTTF |
| Example | No. | of Z | mole) | Z/Mn | Z/Al | Z/Si | Characteristics | (h) |
| Comparative | 29 | Without Z | | | | | Satisfactory | 1.26.E+02 |
| Example | | | | | | | | |
| Comparative | 30 | W | 0.002 | 0.02 | 0.13 | 0.03 | Satisfactory | 1.85.E+02 |
| Example | | | | | | | | |
| Example | 31 | W | 0.005 | 0.02 | 0.21 | 0.04 | Satisfactory | 2.49.E+02 |
| Example | 32 | W | 0.02 | 0.02 | 0.50 | 0.07 | Satisfactory | 1.16.E+03 |
| Example | 2 | W | 0.33 | 0.16 | 0.69 | 0.22 | Satisfactory | 1.36.E+03 |
| Example | 33 | W | 0.75 | 0.34 | 0.75 | 0.38 | Satisfactory | 1.06.E+03 |
| Example | 34 | W | 0.80 | 0.36 | 0.80 | 0.40 | Satisfactory | 2.50.E+02 |
| Comparative | 35 | W | 0.90 | 0.41 | 0.90 | 0.43 | Satisfactory | 1.85.E+02 |
| Example | | | | | | | | |

As can be seen from Table 4, in Sample Nos. 31 to 34 in which the content of W was changed within a range of 0.005 parts by mole or more and 0.80 parts by mole or less, the temperature characteristics and the high-temperature load life were satisfactory. In contrast, in Sample Nos. 29 and 30 in which the content of W was excessively small, and in Sample No. 35 in which the content of W was excessively large, the reliability deteriorated.

### Experimental Example 5

Results of Sample Nos. 41 to 44 in which Z/Mn was mainly changed from Sample No. 2, Sample Nos. 51 to 54 in which Z/Al was mainly changed from Sample No. 2, and Sample Nos. 61 to 64 in which Z/Si was mainly changed from Sample No. 2 are shown in Tables 5 to 7.

TABLE 5

| Example/ | | | Additive | MnO | Al₂O₃ | SiO₂ |
|---|---|---|---|---|---|---|
| Comparative | Sample | Perovskite-Type Compound | Elements Other | (parts by | (parts by | (parts by |
| Example | No. | (Based on Number of Atoms) | Than Z | mole) | mole) | mole) |
| Example | 41 | (Ca_{0.70}Sr_{0.30})(Zr_{0.96}Ti_{0.03}Hf_{0.01})O₃ | Mn, Al, Si | 5.00 | 0.24 | 1.50 |
| Example | 42 | (Ca_{0.70}Sr_{0.30})(Zr_{0.96}Ti_{0.03}Hf_{0.01})O₃ | Mn, Al, Si | 2.20 | 0.24 | 1.50 |
| Example | 2 | (Ca_{0.70}Sr_{0.30})(Zr_{0.96}Ti_{0.03}Hf_{0.01})O₃ | Mn, Al, Si | 2.06 | 0.24 | 1.50 |
| Example | 43 | (Ca_{0.70}Sr_{0.30})(Zr_{0.96}Ti_{0.03}Hf_{0.01})O₃ | Mn, Al, Si | 0.40 | 0.24 | 1.50 |
| Example | 44 | (Ca_{0.70}Sr_{0.30})(Zr_{0.96}Ti_{0.03}Hf_{0.01})O₃ | Mn, Al, Si | 0.38 | 0.24 | 1.50 |

| Example/ | | | Z | | | | | |
|---|---|---|---|---|---|---|---|---|
| Comparative | Sample | Type | (parts by | | | | Temperature | MTTF |
| Example | No. | of Z | mole) | Z/Mn | Z/Al | Z/Si | Characteristics | (h) |
| Example | 41 | W | 0.024 | 0.0048 | 0.05 | 0.016 | Satisfactory | 2.96.E+02 |
| Example | 42 | W | 0.050 | 0.023 | 0.10 | 0.03 | Satisfactory | 1.12.E+03 |
| Example | 2 | W | 0.33 | 0.160 | 0.69 | 0.22 | Satisfactory | 1.36.E+03 |
| Example | 43 | W | 0.56 | 1.400 | 1.17 | 0.37 | Satisfactory | 1.15.E+03 |
| Example | 44 | W | 0.66 | 1.737 | 1.38 | 0.44 | Satisfactory | 4.69.E+02 |

TABLE 6

| Example/ | | | Additive | MnO | Al₂O₃ | SiO₂ |
|---|---|---|---|---|---|---|
| Comparative | Sample | Perovskite-Type Compound | Elements Other | (parts by | (parts by | (parts by |
| Example | No. | (Based on Number of Atoms) | Than Z | mole) | mole) | mole) |
| Example | 51 | (Ca_{0.70}Sr_{0.30})(Zr_{0.96}Ti_{0.03}Hf_{0.01})O₃ | Mn, Al, Si | 2.06 | 0.80 | 1.50 |
| Example | 52 | (Ca_{0.70}Sr_{0.30})(Zr_{0.96}Ti_{0.03}Hf_{0.01})O₃ | Mn, Al, Si | 2.06 | 0.70 | 1.50 |
| Example | 2 | (Ca_{0.70}Sr_{0.30})(Zr_{0.96}Ti_{0.03}Hf_{0.01})O₃ | Mn, Al, Si | 2.06 | 0.24 | 1.50 |
| Example | 53 | (Ca_{0.70}Sr_{0.30})(Zr_{0.96}Ti_{0.03}Hf_{0.01})O₃ | Mn, Al, Si | 2.06 | 0.13 | 1.50 |
| Example | 54 | (Ca_{0.70}Sr_{0.30})(Zr_{0.96}Ti_{0.03}Hf_{0.01})O₃ | Mn, Al, Si | 2.06 | 0.11 | 1.50 |

| Example/ | | | Z | | | | | |
|---|---|---|---|---|---|---|---|---|
| Comparative | Sample | Type | (parts by | | | | Temperature | MTTF |
| Example | No. | of Z | mole) | Z/Mn | Z/Al | Z/Si | Characteristics | (h) |
| Example | 51 | W | 0.05 | 0.02 | 0.03 | 0.03 | Satisfactory | 2.42.E+02 |
| Example | 52 | W | 0.08 | 0.04 | 0.06 | 0.06 | Satisfactory | 1.08.E+03 |
| Example | 2 | W | 0.33 | 0.16 | 0.69 | 0.22 | Satisfactory | 1.36.E+03 |
| Example | 53 | W | 0.39 | 0.19 | 1.45 | 0.26 | Satisfactory | 1.24.E+03 |
| Example | 54 | W | 0.42 | 0.20 | 1.90 | 0.28 | Satisfactory | 3.41.E+02 |

TABLE 7

| Example/ | | | Additive | MnO | Al₂O₃ | SiO₂ |
|---|---|---|---|---|---|---|
| Comparative | Sample | Perovskite-Type Compound | Elements Other | (parts by | (parts by | (parts by |
| Example | No. | (Based on Number of Atoms) | Than Z | mole) | mole) | mole) |
| Example | 61 | (Ca_{0.70}Sr_{0.30})(Zr_{0.96}Ti_{0.03}Hf_{0.01})O₃ | Mn, Al, Si | 2.06 | 0.24 | 3.50 |
| Example | 62 | (Ca_{0.70}Sr_{0.30})(Zr_{0.96}Ti_{0.03}Hf_{0.01})O₃ | Mn, Al, Si | 2.06 | 0.24 | 2.08 |
| Example | 2 | (Ca_{0.70}Sr_{0.30})(Zr_{0.96}Ti_{0.03}Hf_{0.01})O₃ | Mn, Al, Si | 2.06 | 0.24 | 1.50 |
| Example | 63 | (Ca_{0.70}Sr_{0.30})(Zr_{0.96}Ti_{0.03}Hf_{0.01})O₃ | Mn, Al, Si | 2.06 | 0.24 | 0.93 |
| Example | 64 | (Ca_{0.70}Sr_{0.30})(Zr_{0.96}Ti_{0.03}Hf_{0.01})O₃ | Mn, Al, Si | 2.06 | 0.24 | 0.77 |

| Example/ | | | Z | | | | | |
|---|---|---|---|---|---|---|---|---|
| Comparative | Sample | Type | (parts by | | | | Temperature | MTTF |
| Example | No. | of Z | mole) | Z/Mn | Z/Al | Z/Si | Characteristics | (h) |
| Example | 61 | W | 0.024 | 0.012 | 0.05 | 0.007 | Satisfactory | 3.81.E+02 |
| Example | 62 | W | 0.030 | 0.015 | 0.06 | 0.014 | Satisfactory | 1.24.E+03 |
| Example | 2 | W | 0.330 | 0.16 | 0.69 | 0.220 | Satisfactory | 1.36.E+03 |
| Example | 63 | W | 0.400 | 0.19 | 0.84 | 0.430 | Satisfactory | 1.00.E+03 |
| Example | 64 | W | 0.500 | 0.24 | 1.05 | 0.650 | Satisfactory | 4.88.E+02 |

As can be seen from Tables 5 to 7, in respective examples in which the content of each element was changed within a predetermined range, the temperature characteristics and the high-temperature load life were satisfactory.

### REFERENCE SIGNS LIST

1 multilayer ceramic capacitor
2 dielectric layer
3 inner electrode layer
4 outer electrode
10 element body

What is claimed is:

1. A dielectric ceramic composition comprising:
a perovskite-type compound represented by the composition formula (Ca₁₋ₓ₋ₚSrₓBaₚ)ₘ(Zr_{1-y-z}Ti_{y}Hf_{z})O₃ as a main component in terms of number of atoms,
wherein the following conditions are satisfied:
0≤x<1.00, 0≤p<1.00, 0.9<m<1.1, 0≤y≤0.10, and 0≤z<1.00,
the dielectric ceramic composition further comprises Al, Si, Z, and at least one selected from the group consisting of Mn and Mg,
Z comprises at least one selected from the group consisting of V, Nb, Ta, and W,
a content of Al is 0.01 parts by mole or more and 1.00 part by mole or less in terms of Al₂O₃, a content of Si is 0.08 parts by mole or more and 4.0 parts by mole or less in terms of SiO₂, the total content of Mn and Mg is 0.10 parts by mole or more and 5.0 parts by mole or less, and the total content of Z is 0.005 parts by mole or more and 0.80 parts by mole or less, with respect to 100 parts by mole of the total content of Zr, Ti, and Hf.

2. The dielectric ceramic composition according to claim 1, wherein the following conditions are satisfied:
0≤x<0.80, 0≤p<0.40, 0.9<m<1.1, 0≤y≤0.10, and 0≤z<0.20, and
the total content of Z is 0.02 parts by mole or more and 0.75 parts by mole or less.

3. The dielectric ceramic composition according to claim 1, wherein the following conditions are satisfied:
0≤x<0.40, p=0, 0.9<m<1.1, 0.01<y≤0.10, and 0≤z<0.20, and
the total content of Z is 0.02 parts by mole or more and 0.75 parts by mole or less.

4. The dielectric ceramic composition according to claim 1, wherein, in terms of number of atoms, a value obtained by dividing the total content of Z by a content of Mn is set as Z/Mn, a value obtained by dividing the total content of Z by the content of Al is set as Z/Al, and a value obtained by dividing the total content of Z by the content of Si is set as Z/Si, the following conditions are satisfied:
$$0.005 \leq Z \text{/Mn} < 1.5 , 0.05 \leq Z \text{/Al} < 1.5 , and 0.01 \leq Z \text{/Si} < 0.45 .$$

5. The dielectric ceramic composition according to claim 1, wherein Z comprises at least one selected from the group consisting of W and Nb.

6. The dielectric ceramic composition according to claim 1, wherein Z comprises W.

7. The dielectric ceramic composition according to claim 1, wherein a relationship of 0.01<y≤0.07 is satisfied.

8. The dielectric ceramic composition according to claim 1, wherein a relationship of 0≤z≤0.01 is satisfied.

9. The dielectric ceramic composition according to claim 1, wherein, a content of each element other than Ca, Sr, Ba, Zr, Ti, Hf, O, Mn, Mg, Al, Si, and Z is 0 parts by mole or more and 5.0 parts by mole or less, with respect to 100 parts by mole of the total content of Zr, Ti, and Hf.

10. A multilayer ceramic electronic device comprising the dielectric ceramic composition according to claim 1.
